(19) United States
(12) Patent Application Publication
(10) Pub. No.: US 2022/0156270 A1
(43) Pub. Date: May 19, 2022

(54) Data-Driven Academia and Industry Matching Platform

(71) Applicant: Science First Partnerships, LLC, Cleveland, OH (US)

(72) Inventors: Batool Akhtar-Zaidi, Cleveland, OH (US); Neel Patel, Cleveland, OH (US)

(73) Assignee: Science First Partnerships, LLC, Cleveland, OH (US)

(21) Appl. No.: 17/526,235

(22) Filed: Nov. 15, 2021

Related U.S. Application Data
(60) Provisional application No. 63/198,829, filed on Nov. 16, 2020.

(51) Int. Cl. G06F 16/2457; G06F 16/2452; G06F 16/2455; G06N 3/08

(52) U.S. Cl. CPC G06F 16/24578; G06N 3/08; G06F 16/24556; G06F 16/24522

(57) ABSTRACT

The present invention relates to a method for matching research grants with relevant researchers and generating a report based on that match. Descriptions of grants and information on researchers are entered into a database. The entered information is converted into vectors based on a set of parameters using a natural language processing model. A neural network is trained by iterating data sets to identify relevant matches between vectors. The neural network includes a plurality of convolution layers filtering the relevant vectors matching based on the assigned parameters. A report comprising the matches as well as a numerical rating indicating the relevance of the matches.

### CROSS-REFERENCE TO RELATED APPLICATION

This utility patent application claims priority from and the benefit of the filing date of co-pending Provisional Patent Application Ser. No. 63/198,829 filed Nov. 16, 2020 titled “Data-Driven Academia and Industry Matching Platform” by Batool Akhtar-Zaidi in accordance with 35 U.S.C. §§ 119(e) and 120, the disclosure of which is incorporated herein by reference.

### TECHNICAL FIELD

The invention generally relates to searching structured data via natural language processing and machine-learning neural networks. The neural network improves the functioning of the computer by enhancing matching that could otherwise not be done in a generic computer. More specifically, the invention relates to searching through data in order to match scientific research descriptions to both relevant scientists and extramural funding opportunities (across public, private, and philanthropic sources).

### BACKGROUND OF THE INVENTION

There is a need for scientific researchers to identify extramural funding opportunities across public, commercial, and philanthropic sources and other scientific researchers to facilitate lifesaving research projects and partnerships.

Conventional methods to identify both extramural funding opportunities and other scientific researchers are manual, despite the unmet need for computational tools to identify appropriate matches by systematically aggregating and searching through massive datasets.

U.S. Pat. No. 11,048,867 B2 discloses a method for extracting tabular data from a document. Through use of a neural network, a set of pixel coordinates are identified for a bordered table and in a second document, corresponding coordinates are identified. Tabular data is then extracted based on these coordinates. This neural network includes four layers inside a generated LSTM. A recurrent neural network may feed the output of the neural network as an input for the neural network. These neural network layers may utilize a hyperbolic tangent activation function.

U.S. Pat. No. 11,086,857 B1 discloses a method and system for data management. This reference uses a machine learning process to train an analysis model to generate subword embeddings. These embeddings correspond to vectorized representations of portions of a search term entered by a user. Augmented query data is generated based on these embeddings which can be used to provide a user with assistance in identifying or locating entered data.

U.S. Pat. No. 7,516,142 B2 provides a system, method, and program product for optimizing a research grant portfolio. This reference teaches a method for matching researchers with research grant opportunities. In this reference, a grant description as well as information describing a researcher is fed into a database. That database is then text-mined and used to match a researcher to a research grant opportunity. A financial gain is then defined, computed, and assigned to the matches between researcher and research grant opportunities.

### BRIEF SUMMARY OF THE INVENTION

It is therefore an object of the present invention to provide for a platform to match a research description with extramural funding opportunities and relevant scientists.

It is yet another object of the present invention to provide for a computing system which continually optimizes the methods for matching.

The following invention discloses a method for customized matching of research description with extramural funding opportunities and relevant scientists.

By providing a computer system having a central processing unit, a memory unit, an aggregate database, and a neural network, the system is able to collect a plurality of available extramural funding opportunities and scientists and enter the available extramural funding opportunities and scientists into the aggregate database. Semantic data entered into the aggregate database regarding both a scientific research description and any extramural funding opportunities may include a research area, title, contact information, description, and possible applications of said extramural funding opportunity. These extramural funding opportunities may be collected by searching an online source to find the plurality of available extramural funding opportunities across public, commercial, and philanthropic sources.

Upon receiving a scientific research description into the aggregate database and analyzing the scientific research description by using a natural language processing model, the neural network is trained to identify matches between the scientific research description and at least one available extramural funding opportunity by iterating the plurality of available extramural funding opportunities.

Matches between the scientific research description and any available extramural funding opportunities with the aggregate database are derived within the central processing unit. In other embodiments, the matches may be identified through use of a natural language processing model.

Upon matching, a numerical rating is generated with the central processing unit to indicate the relevance of an available extramural funding opportunity and an available scientist profile, based on the matches. In some embodiments, the numerical rating is generated through use of a trained neural network by the central processing unit. In other embodiments, the numerical rating is generated through use of a quantitative metric by the central processing unit.

Finally, a report is generated with the central processing unit that comprises at least one most relevant extramural funding opportunity to the scientific research description, and at least one relevant scientist profile, based on said numerical ratings.

Additionally, the following invention also discloses a method for customized matching of extramural funding opportunities with scientific research descriptions. By providing a computer system having a central processing unit, a memory unit, an aggregate database, and a neural network, the system is able to collect a plurality of available scientific research descriptions and enter the plurality of available scientific research descriptions into the aggregate database. The plurality of available scientific research descriptions is collected by the central processing unit through searching an online source to find the plurality of available scientific research descriptions.

Upon receiving an extramural funding opportunity into the aggregate database, it is analyzed by using a natural language processing model. The extramural funding opportunity is drawn from a group consisting of the following: research area, title, contact information, description, and possible applications of said extramural funding opportunity.

A neural network is then trained to identify matches between the extramural funding opportunity and at least one available scientific research description by iterating the plurality of available scientific research description which creates matches between the extramural funding opportunity and any available scientific research description with the aggregate database in the central processing unit. The plurality of available scientific research descriptions is drawn from a group by the central processing unit consisting of at least one of the following: research area, title, contact information, description, and possible applications of said scientific research description. In other embodiments, the matches may be identified through use of a natural language processing model.

Once matches are found, a numerical rating is generated with the central processing unit to indicate the relevance of an available scientific research description based on the matches. The numerical rating is generated through use of a trained neural network by the central processing unit.

Finally, a report is generated with the central processing unit that comprises at least one most relevant scientific research description to the extramural funding opportunity and scientist profile based on said numerical ratings.

The invention achieves the above objects, and other objects and advantages which will become apparent from the description which follows.

### BRIEF DESCRIPTION OF THE DRAWINGS

FIG. 1a is a flow diagram depicting the match process between a scientific research description and at least one extramural funding opportunity.

FIG. 1b is a flow diagram illustrating the iterative process of training a neural network.

FIG. 2 is a diagram identifying different sources used to compile semantic data for extramural funding opportunities and scientific research descriptions.

FIG. 3 is a flow diagram depicting the match process between a scientist description and an extramural funding opportunity utilizing a neural network.

FIG. 4 is a flow diagram depicting the match process between a scientist description and an extramural funding opportunity utilizing a natural language processing model.

FIG. 5 is a flow diagram illustrating the structure of a neural network.

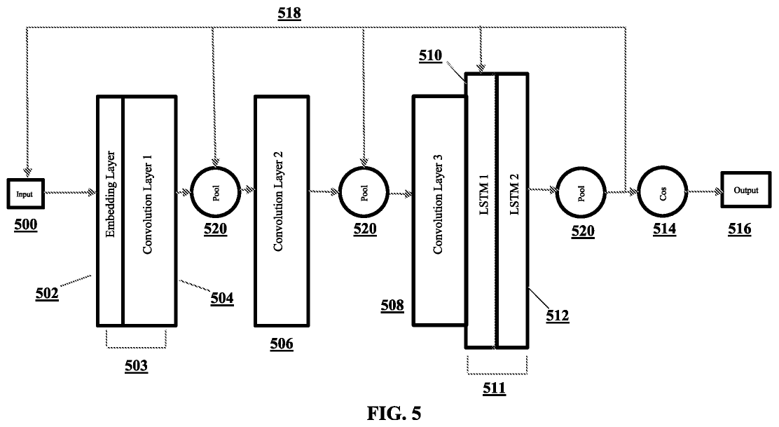

FIG. 6 is a flow diagram depicting the match process between an extramural funding opportunity and at least one scientific research description.

FIG. 7 is a flow diagram depicting the match process between an extramural funding opportunity and a scientist description utilizing a neural network.

FIG. 8 is a flow diagram depicting the match process between an extramural funding opportunity and a scientist description utilizing a natural language processing model.

### DETAILED DESCRIPTION OF THE PREFERRED EMBODIMENTS

The disclosed method for matching extramural funding opportunities which come from private funding sources with relevant scientific research descriptions and generating a report based on that match is not related to any fundamental data processing practice, mental steps, or pen and paper-based solutions, and instead is directed to providing solutions to new and existing problems associated with neural networks and machine-learning methodologies.

The present invention is well suited to a wide variety of computer systems operating over numerous topologies. The technical solutions in the embodiments of the present invention are implemented by at least one physical central processing unit (“CPU”) but could also include a web-based server, a network, or a cloud storage system. The term “central processing unit” includes, but is not limited to, a desktop computing system; a mobile computing system; or a server computing system. The CPU includes at least a physical core displayed on a virtual machine which can be used for a variety of purposes beyond those discussed by this invention.

The actions of the CPU are stored within at least one memory unit. The memory unit could be a physical unit within the CPU but could also include a web-based server, a network, or a cloud storage system. The memory unit may also contain data not executed by the CPU including, but not limited to, internal data sets and databases.

The physical hardware of the invention is utilized to identify matches between a scientific research description and at least one extramural funding opportunity. Upon receiving an initial scientific research description, the scientific research description is entered into an aggregate database (100).

The aggregate database, which exists within the memory unit, contains both the scientific research description and a large quantity of extramural funding opportunities. The aggregate database may exist in a variety of formats or structures. In one embodiment, the aggregate database may be represented as a table. The aggregate database stores both qualitative information, known as semantic data (200), and quantitative information, later disclosed as vector data, regarding the scientific research description and extramural funding opportunities. This includes information regarding extramural funding opportunities, including the particular area of research that a particular grant may be directed towards. In one embodiment, this area could focus on specialized segments of pharmaceutical research. The titles of the available grants could be included as well. Contact information of persons involved in the grant is also included, as well as a description of the research grant itself. Applications for opportunity regarding objectives of relevant grants may also be included. Likewise, the scientific research description could include the same information in order to more accurately match.

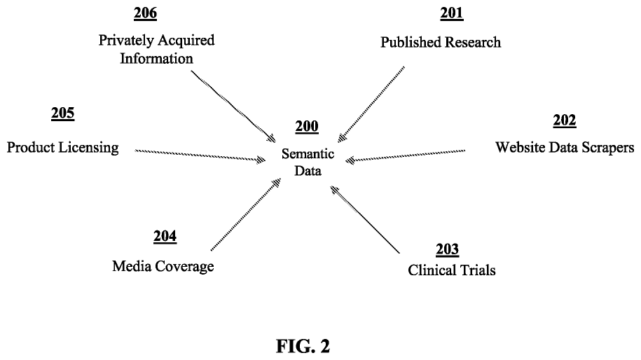

FIG. 2 discloses how semantic data within the memory unit is obtained. This data is obtained through a number of non-limiting sources for input into the aggregate database. In one embodiment, semantic data may be found in published research (201). In another embodiment, the semantic data may be scraped using a website data scraper (202). In another embodiment, semantic data may result from information regarding clinical trials (203). In another embodiment, semantic data may be found in media coverage (204). In another embodiment, semantic data may be sourced from product licensing information (205). In another embodiment, semantic data may be sourced as privately acquired information from commercial funding (206). Further embodiments allow for information to be obtained through privately acquired means from particular individuals with a working knowledge of ongoing funding opportunities within the pharmaceutical industry.

Using a natural language processing model, the scientific research description and accompanying qualitative information is analyzed and converted into a 100-dimensional vector and stored in the aggregate database. In another embodiment, semantic data may be found in published research (102). In one embodiment, the natural language processing model may convert the scientific research description into a different-sized high dimensional vector. In one embodiment, the natural language processing model may include a paragraph vector algorithm. In one embodiment, the paragraph vector algorithm may be a commonly utilized open-source methodology such as Doc2Vec.

Natural language processing models encompass machine-learning algorithms that can continue to identify patterns. Thus, the vector conversion done by a paragraph vector methodology may incorporate a variety of linguistic patterns into the 100-dimensional vector. In one embodiment, a pattern paragraph vector can identify is synonymy. Utilizing learned context such as synonymy, the natural processing model will output a 100-dimensional vector.

The natural language processing model will match 100-dimensional vectors to other 100-dimensional vectors within the aggregate database by using a neural network (310). The neural network is a machine-learning structure which requires training in order to continually improve its accuracy.

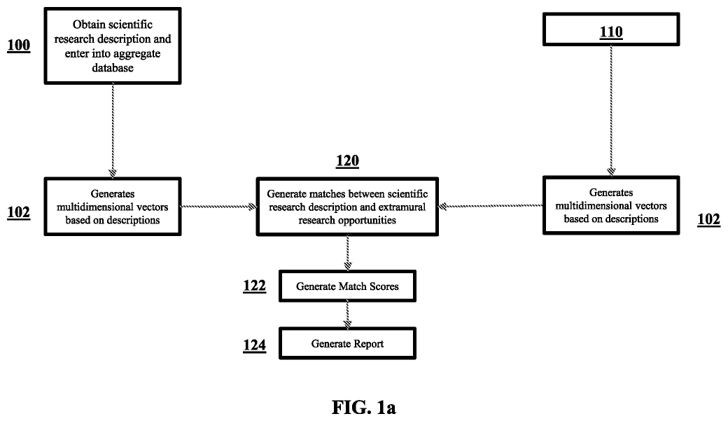

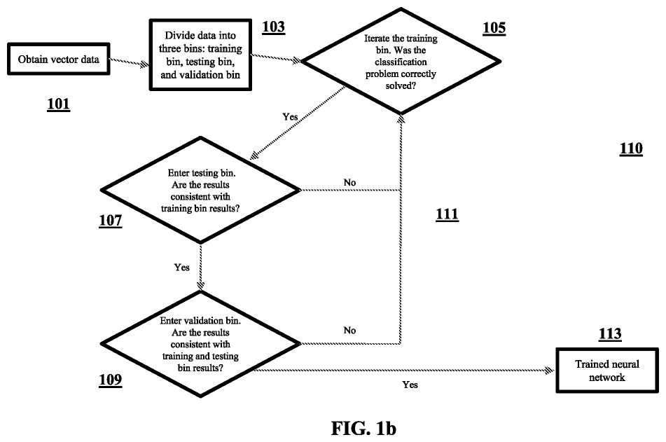

To effectively match scientists with extramural funding opportunities (120), the neural network must utilize semantic data which comprises abstracts of research grants publicly available through the National Institute of Health. The semantic data is converted to vector data by a natural language processing model (102). FIG. 1B (110) discloses the training for a neural network which occurs by randomly dividing the vector data into three temporary bins: a training bin, a testing bin, and a validation bin (103). In one embodiment, 70% of the vector data is assigned to the training bin, 15% of the vector data is assigned to the testing bin, and 15% of the vector data is assigned to the validation set.

105 discloses the iteration of the training bin. The training bin is assigned a question and an answer. The neural network is structured as a non-linear multi-class classification problem in which the neural network solves for which extramural funding opportunity would have the highest probability of funding the scientific research description. The training bin runs through the neural network in iterations.

After each training iteration, the model performance is assessed by predicting labels for the remaining testing and validation bins and also computes validation accuracy. The validation accuracy is a quantitative reflection of how the neural network adapts to the training bin data by altering internal parameters, known as weights, based on loss computed during the iterations using this accuracy metric. The training ceases once five consecutive iterations are performed without any change in validation accuracy. Once these iterations are complete, labels are predicted for the vector data included in the training bins.

Following the training, the testing bin data runs through the neural network (107). Using user analysis, a user will qualitatively determine whether the testing data produces accurate results. If so, the validation bin data runs through the neural network as a second confirmation (109). If either the testing or validation bin data produces non-ideal results according to the user, the weights within the neural network are changed, the data is randomly re-divided and the entire training process begins again (111). In one embodiment, the neural network may be continuously trained with more data sets.

Once trained, the neural network (113) may begin to predict matches between the scientific research description and extramural funding opportunities (310). The neural network comprises several layers, including an embedding layer (502) and three separate convolution layers (504, 506, 508). In some embodiments, the neural network may include hidden layers. In the first layer (503), the vectors based on the established parameters are fed into the embedding layer (502). A first convolution layer is directly connected to the embedding layer (503) and utilizes a sliding window algorithm to analyze the vector and narrows the amount of information passing through this first convolution layer (504). In doing so, this first convolution layer (504) filters the vector data based on weights so that only relevant vector data passes through the convolution layer (504). This establishes local vectors which are a smaller portion of the 100-dimensional vector entered into the neural network. The vectors pass through several convolution layers (504, 506, 508) that repeatedly filter the vectors, allowing only vectors determined to be relevant based on assigned parameters to pass through each convolution layer (520).

The local vectors filtered by this first convolution layer (504) are pooled together and condensed (520). A second convolution layer (506) filters the vectors as the first convolution layer (504) did, further narrowing the vectors that pass through the second convolution layer based on relevant assigned parameters. The filtered vectors are again pooled and condensed (520).

A third convolution layer (508) is connected to two layers of Long Short Term Memory Units (“LSTM”) (511). The LSTM layers (511) compile the relevant vectors that have passed through the convolution layers and long term dependencies are extracted among the vectors. This allows the filtered local vectors and 100-dimensional extramural funding opportunity vectors corresponding based on assigned parameters and then passed on to the fully connected layers of the LSTM (511). Thus, both local and global features from the input vectors are extracted by using convolution and LSTM layers respectively. Upon completion, the local vectors are pooled and expanded to a 100-dimensional vector (520).

Using the natural language processing model, a match score can be calculated to predict how relevant a particular extramural funding opportunity may be to the given scientific research description (408). By utilizing the vector representations derived from the natural language processing model, the 100-dimensional vector generated for the scientific research description is compared to the 100-dimensional vector generated for the extramural funding opportunity. In one embodiment, the match is quantified using a cosine similarity function (514) which reflects the cosine of the angle between the scientific research description vector and the extramural funding opportunity vector and is then used to calculate a percentage. According to this calculation, the higher the cosine similarity (514), the higher the match score. In some embodiments, match scores are generated by a similar quantitative analysis (122).

The methods disclosed herein are also suitable for matching a private entity that offers an extramural funding opportunity with a scientific research description. As a result, the methods disclosed herein also disclose a method of matching an extramural research opportunity to a scientific research description.

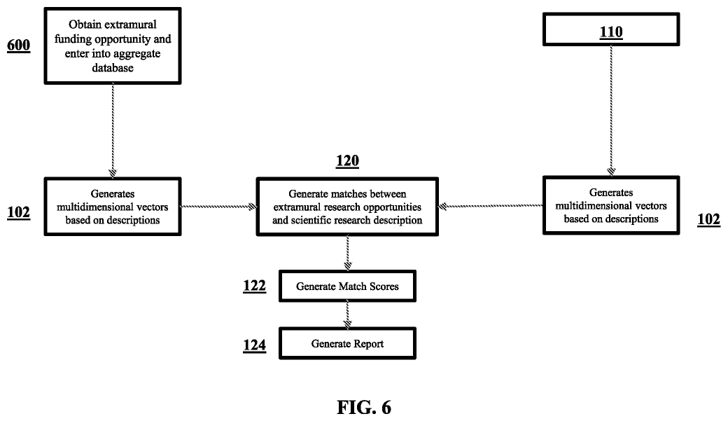

FIGS. 6, 7, and 8 provide depictions relevant to a method for customized matching of scientific research descriptions with extramural funding opportunities in a manner analogous to the matching of extramural funding opportunities with scientific research descriptions as depicted in FIGS. 1a, 3, and 4. FIG. 6 shows a flow diagram depicting the match process between an extramural funding opportunity and at least one scientific research description. This follows the same process as that depicted in FIG. 1a, but provides for matching in the opposite way.

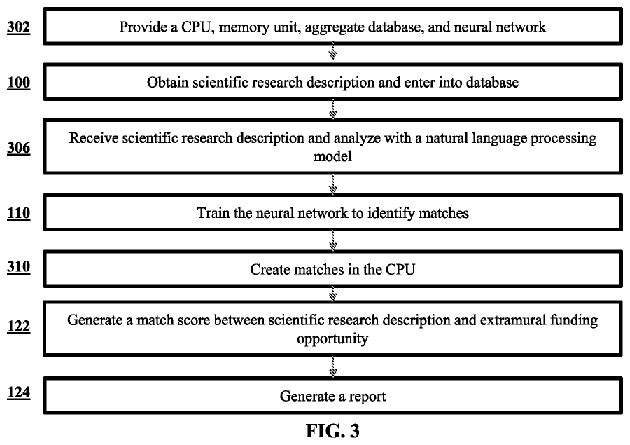

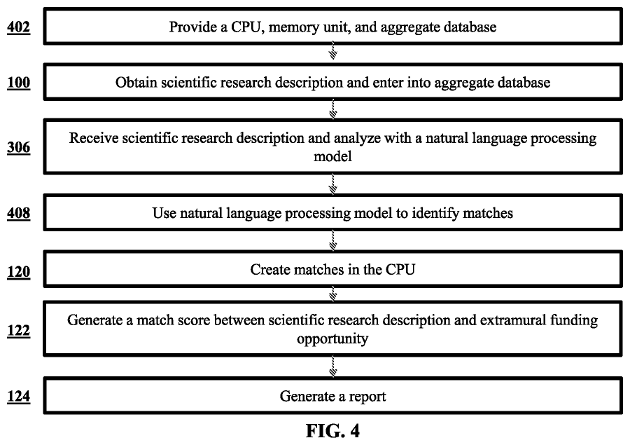

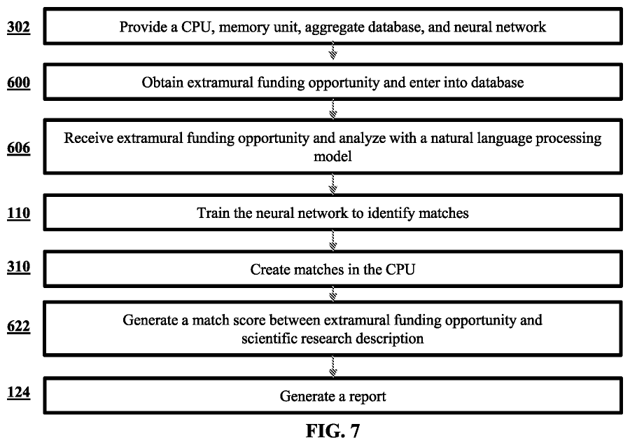

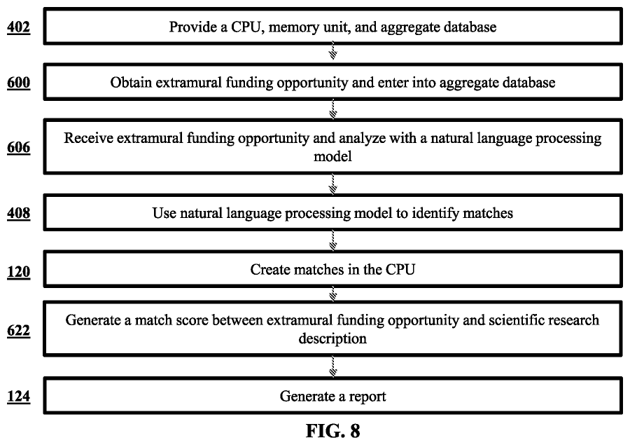

FIG. 7 shows a flow diagram depicting the match process between an extramural funding opportunity and a scientist description utilizing a neural network, where the neural network is trained using the same iterative process described in FIG. 1b. This is analogous to the process depicted in FIG. 3. Similarly, FIG. 8 depicts the match process between an extramural funding opportunity and a scientist description utilizing a natural language processing mode following the same model described in FIG. 4. A match score between extramural funding opportunity and scientific research description is generated (622) and a report is sent to the academic scientist.

Any references to any particular programming language are provided for illustrative purposes only and are not intended to be limiting. Those of ordinary skill in the art will recognize that a variety of programming languages may be used to construct the present invention.

Unless specified, the methods disclosed herein may be performed in any order. The particular order of the process steps and/or operations discussed herein do not limit the scope of the invention as claimed below.

Those of ordinary skill in the art will conceive of other alternate embodiments of the invention upon reviewing this disclosure. Thus, the invention is not to be limited to the above description, but is to be determined in scope by the claims which follow.

What is claimed is:

1. A method for customized matching of scientific research descriptions to both extramural funding opportunities and scientist profiles, comprising:
providing a computer system having a central processing unit, a memory unit, an aggregate database, and a neural network;
collecting a plurality of available extramural funding opportunities and entering the plurality of available extramural funding opportunities into the aggregate database;
collecting a plurality of available scientist profiles and entering the plurality of available scientist profiles into the aggregate database;
receiving a scientific research description into the aggregate database and analyzing the scientific research description by using a natural language processing model;
training the neural network to identify matches between the scientific research description and at least one available extramural funding opportunity and at least one available scientist profile by iterating the plurality of available extramural funding opportunities;
training the neural network to identify matches between the scientific research description and at least one available scientist profile by iterating the plurality of available scientist profiles;
creating matches between the scientific research description and any available extramural funding opportunities and scientist profiles within the aggregate database in the central processing unit;
generating a numerical rating with the central processing unit to indicate the relevance of an available extramural funding opportunity and available scientist profile based on the matches; and
generating a report with the central processing unit that comprises at least one most relevant extramural funding opportunity to the scientific research description based on said numerical ratings, and at least one most relevant scientist profile based on said numerical ratings.

2. The method of claim 1, wherein the plurality of available extramural funding opportunities and the plurality of available scientist profiles are collected by the central processing unit through searching an online source to find the plurality of available extramural funding opportunities and available scientist profiles.

3. The method of claim 1, wherein the plurality of available extramural funding opportunities and a plurality of available scientist profiles are drawn from a group by the central processing unit consisting of at least one of the following: research area, contact information, relevant NIH biosketches, descriptions, any other available information gathered from the public domain, and any other information gathered through proprietary sources.

4. The method of claim 1, wherein the scientific research description is drawn from a group consisting of the following: research area, title, contact information, description, possible applications of said academic research description, and any other relevant information.

5. The method of claim 1, wherein the numerical rating is generated through use of a trained neural network by the central processing unit.

6. A method for customized matching of academic research descriptions and extramural funding opportunities, comprising:
providing a computer system having a central processing unit, a memory unit, and an aggregate database;
collecting a plurality of available extramural funding opportunities and entering the plurality of available extramural funding opportunities into the aggregate database;
receiving an academic research description into the aggregate database and analyzing the academic research description by using a natural language processing model;
utilizing the natural language processing model to identify matches between the academic research description and at least one available extramural funding opportunities;
creating matches between the academic research description and any available extramural funding opportunities with the aggregate database in the central processing unit,
generating a numerical rating with the central processing unit to indicate the relevance of an available extramural funding opportunity based on the matches obtained; and
generating a report with the central processing unit that comprises at least one most relevant extramural funding opportunity to the academic research description based on said numerical ratings.

7. The method of claim 6, wherein the plurality of available extramural funding opportunities is collected by the central processing unit through searching an online source to find the plurality of available extramural funding opportunities.

8. The method of claim 6, wherein the plurality of available extramural funding opportunities is drawn from a group by the central processing unit consisting of at least one of the following: research area, contact information, relevant NIH biosketches, descriptions, any other available information gathered from the public domain, and any other information gathered through proprietary sources.

9. The method of claim 6, wherein the scientific research description is drawn from a group consisting of the following: research area, title, contact information, description, and possible applications of said academic research description.

10. The method of claim 6, wherein the numerical rating is generated through use of a quantitative metric by the central processing unit.

11. A method for customized matching of scientific research descriptions to both extramural funding opportunities and scientist profiles, comprising:
providing a computer system having a central processing unit, a memory unit, an aggregate database, and a neural network;
collecting a plurality of available extramural funding opportunities and entering the plurality of available extramural funding opportunities into the aggregate database;
collecting a plurality of available scientist profiles and entering the plurality of available academic research descriptions into the aggregate database;
receiving scientific research description into the aggregate database and analyzing the scientific research description by using a natural language processing model;
training the neural network to identify matches between the scientific research description and at least one available extramural funding opportunity and at least one available scientist profile by iterating the plurality of available academic research description;
creating matches between the scientific research description and any available extramural funding opportunity and any available scientist profile with the aggregate database in the central processing unit;
generating a numerical rating with the central processing unit to indicate the relevance of an available scientist profile based on the matches; and
generating a report with the central processing unit that comprises at least one most relevant scientific research description, extramural funding opportunity, and at least one most relevant scientist profile based on said numerical ratings.

12. The method of claim 11, wherein the plurality of extramural research opportunities and the plurality of scientist profiles is collected by the central processing unit through searching an online source to find the plurality of available extramural research opportunities and the plurality of scientist profiles.

13. The method of claim 11, wherein the plurality of available extramural research opportunities and the plurality of scientist profiles is drawn from a group by the central processing unit consisting of at least one of the following: research area, contact information, relevant NIH biosketches, descriptions, any other available information gathered from the public domain, and any other information gathered through proprietary sources.

14. The method of claim 11, wherein the extramural funding opportunity is drawn from a group consisting of the following: research area, title, contact information, description, possible applications of said extramural funding opportunity, any other information from the public domain, and any other information from proprietary sources.

15. The method of claim 11, wherein the numerical rating is generated through use of a trained neural network by the central processing unit.

16. A method for customized matching of scientific research descriptions to both extramural funding opportunities and scientist profiles, comprising:
providing a computer system having a central processing unit, a memory unit, and an aggregate database;
collecting a plurality of available extramural funding opportunities and a plurality of available scientist profiles entering the plurality of available academic research descriptions into the aggregate database;
receiving a scientific research description into the aggregate database and analyzing the scientific research description by using a natural language processing model;
utilizing the natural language processing model to identify matches between the scientific research description and at least one available extramural funding opportunity and at least one available scientist profile;
creating matches between the scientific research description and any available extramural funding opportunities and scientist profiles with the aggregate database in the central processing unit;
creating matches between the scientific research description and any available scientist profiles with the aggregate database in the central processing unit;
generating a numerical rating with the central processing unit to indicate the relevance of an available extramural funding opportunity and scientist profile based on the matches obtained; and
generating a report with the central processing unit that comprises at least one most relevant scientific research description to the extramural funding opportunity based on said numerical ratings.

17. The method of claim 16, wherein the plurality of available extramural funding opportunities and scientist profiles is collected by the central processing unit through searching an online source to find the plurality of available academic research descriptions.

18. The method of claim 16, wherein the plurality of available extramural funding opportunities and scientist profiles are drawn from a group by the central processing unit consisting of at least one of the following: research area, title, contact information, description, and possible applications of said academic research descriptions.

19. The method of claim 16, wherein the extramural funding opportunity and the scientist profile is drawn from a group consisting of the following: research area, title, contact information, description, and possible applications of said extramural funding opportunity.

20. The method of claim 16, wherein the numerical rating is generated through use of a quantitative metric by the central processing unit.
